(19) United States
(12) Patent Application Publication
(10) Pub. No.: US 2019/0005516 A1
(43) Pub. Date: Jan. 3, 2019

(54) REAL ESTATE EXPECTED SALES DATE APPLICATION

(71) Applicant: Carrier Corporation, Palm Beach Gardens, FL (US)

(72) Inventor: Tony Spath, West Hartford, CT (US)

(73) Assignee: Carrier Corporation, Palm Beach Gardens, FL (US)

(21) Appl. No.: 16/018,288

(22) Filed: Jun. 26, 2018

Related U.S. Application Data
(60) Provisional application No. 62/527,398, filed on Jun. 30, 2017.

(51) Int. Cl. G06Q 30/02; G06F 17/18; G06Q 30/06

(52) U.S. Cl. CPC G06Q 30/0201; G06Q 30/0205; G06Q 50/16; G06Q 30/0629; G06F 17/18

(57) ABSTRACT

A method for predicting an anticipated sales date for a subject real estate property, includes receiving a subject property; determining a multiple of comparable properties to the subject property; determining showing data for the subject property; determining showing data for at least one of the comparable properties; and predicting an anticipated sales date for the subject property based at least in part on the showing data of the subject property and the showing data for the multiple of comparable properties.

### CROSS-REFERENCE TO RELATED APPLICATIONS

This application claims the benefit of provisional application Ser. No. 62/527,398, filed Jun. 30, 2017.

### BACKGROUND

The present disclosure relates generally to a real estate communication system, and more particularly, to a system and method to predict a sales date for a real estate property.

In the real estate industry, there exists significant activity relating to the sale of a home that is based on agent knowledge. Typically, home sellers start the process of setting a price for their property based off emotions and expectations. A real estate agent may then propose an adjustment to their expectation and strategize a price based on buyer interest or lack thereof.

When an individual puts their property on the market, a seller typically has very little idea how when the sale may be completed. This may undermine the seller's expectation and cause the relationship between seller and the seller's agent to become strained. This may then lead to questions on the value of the agent.

### SUMMARY

A method for predicting an anticipated sales date for a subject property according to one disclosed non-limiting embodiment of the present disclosure includes determining a set of comparable properties based on a subject property; determining showing data for the subject property; determining showing data for at least one of the set of comparable properties; determining historical sale data for at least one of the set of comparable properties; and predicting an anticipated sales date for the subject property based at least in part on the showing data of the subject property, the showing data for the at least one of the set of comparable properties and the historical sale data for the at least one of the set of comparable properties.

A further aspect of the present disclosure includes, wherein predicting the anticipated sales date is performed using regression analysis based on the historical data.

A further aspect of the present disclosure includes, wherein a dependent variable of the regression analysis is the anticipated sales date.

A further aspect of the present disclosure includes, wherein an independent variable of the regression analysis includes publically available data.

A further aspect of the present disclosure includes, wherein the publically available data includes at least one of number of days on the market before sale, property type, year built, lot size, number of bedrooms, number of bathrooms, basement, garage, square feet, location, schools, price, taxes, price history, tax history, cooling type, heating type, appliances included, attic, number of rooms, fireplace, exterior material, driveway type, porch, sewer/water.

A further aspect of the present disclosure includes, wherein an independent variable of the regression analysis includes privately available data.

A further aspect of the present disclosure includes, wherein the privately available data includes a number of showings/time period.

A further aspect of the present disclosure includes, wherein the privately available data includes at least one of an average time at each showing, a maximum time at a showing, an average showing time/square feet, an average showing time/(square feet plus lot size).

A further aspect of the present disclosure includes communicating the anticipated sales date for the subject property to a handheld device operating a predictive sale date application.

A further aspect of the present disclosure includes displaying the anticipated sales date for the subject property on the predictive sale date application as a qualitive measure relative to the demand of the subject property.

A further aspect of the present disclosure includes, wherein the qualitive measure is based on a time associated with the anticipated sales date for the subject property.

A further aspect of the present disclosure includes, wherein the predicting is performed by a showing application on a handheld device.

A further aspect of the present disclosure includes, wherein the predicting is performed by a subsystem.

A further aspect of the present disclosure includes, wherein the set of comparable properties based on the subject property is related to at least one of a comparable geographical area, a comparable price, a comparable number of bedrooms, and a comparable number of bathrooms.

A system for predicting a sales date for a subject property according to one disclosed non-limiting embodiment of the present disclosure includes an electronic key box; an electronic key server in communication with the electronic key box, the electronic key server including a database that stores showing data associated with the electronic key box; a buyer server in communication with the electronic key server; a buyer storage system in communication with the buyer server and the electronic key server, the buyer storage system including a database that stores historical sale data; and a software application configured to determine a set of comparable properties from the property data stored in the buyer storage system based on a subject property stored in the buyer storage system, the software application configured to predict an anticipated sales date for the subject property based at least in part on the showing data of the subject property, the showing data for the at least one of the set of comparable properties and the historical sale data for the at least one of the set of comparable properties.

A further aspect of the present disclosure includes a handheld device running a predictive sale date application, the handheld device in electronic communication with the electronic key server and the electronic key box.

A further aspect of the present disclosure includes, wherein the analytics software application configured to receive privately available data.

A further aspect of the present disclosure includes, wherein the privately available data is received from the electronic key server in communication with at least one electronic key box.

A further aspect of the present disclosure includes, wherein the analytics software application configured to receive publicly available data.

A further aspect of the present disclosure includes, wherein the publicly available data is received from a data center that communicates with a Real Estate Transaction Standard (RETS) framework that stores MLS data.

A further aspect of the present disclosure includes, wherein the software application is hosted on a handheld device, the handheld device in communication with the buyer server.

A further aspect of the present disclosure includes, wherein the software application is hosted on a listing recommendation server, the listing recommendation server in communication with the buyer server and the electronic key server.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a general schematic system diagram of a real estate application system.

FIG. 2 is a schematic diagram of a handheld device.

FIG. 3 is a flowchart of a method to provide communication for a real estate transaction with the system of FIG. 1.

FIG. 4 is a screenshot of the real estate application property listing view.

FIG. 5 is a schematic system diagram of a predictive sale date application in communication with the real estate application system.

FIG. 6 is a flowchart of the predictive sale date application operation.

FIG. 7 is a flowchart of a method to predict a sales date using the predictive sale date application.

FIG. 8 is a screenshot of an interface for a predictive sale date application on a handheld device.

### DETAILED DESCRIPTION

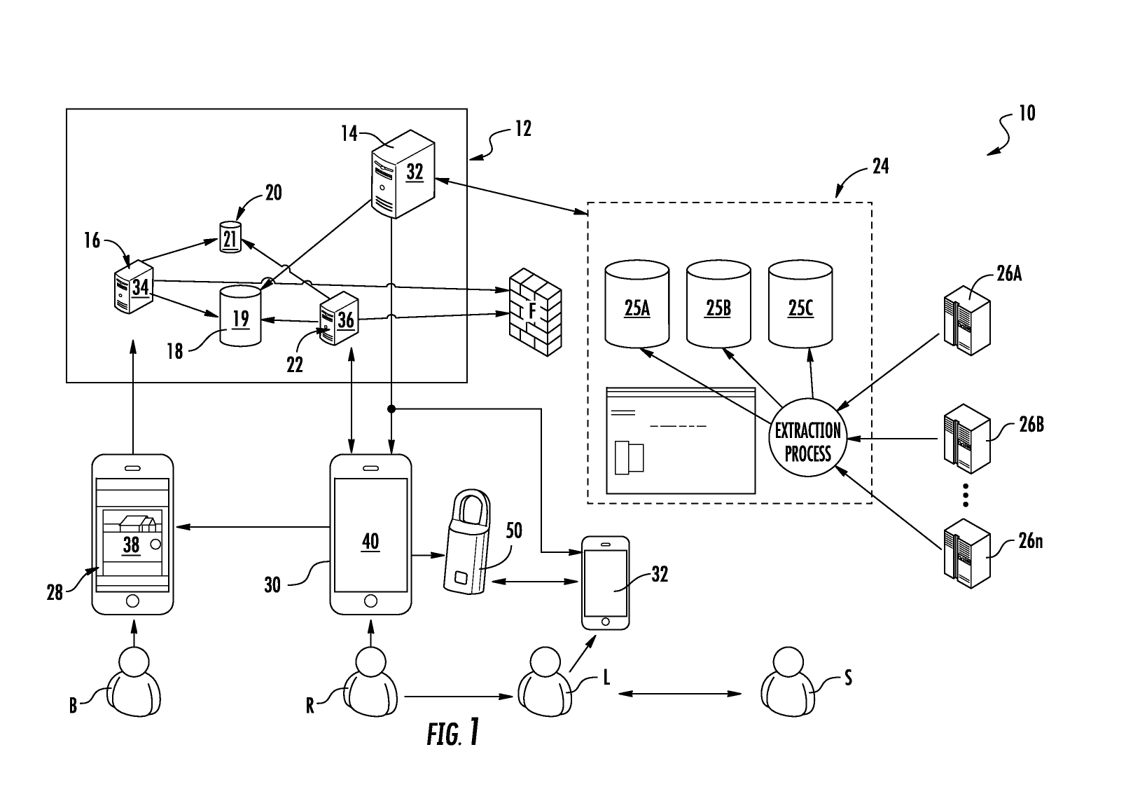

FIG. 1 schematically illustrates a system 10 to facilitate communication for real estate transactions. A showing agent “R” has a fiduciary duty to a home buyer “B” while a listing agent “L” has a fiduciary duty to a home seller “S.” The showing agent “R” typically shows the property to the home buyer “B.” The listing agent “L” typically communicates with the buyer “B” only indirectly, such as by communication with the showing agent “R” who then communicates information to and from the buyer “B.” Although only particular agents are referred to in the illustrated embodiments, the functions of such personnel may be otherwise assigned or rearranged. For example, the listing agent “L” may utilize a seller's assistant.

Showing information is accessible through the system 10 so that the listing agent “L” can generate reports for their seller “S”, send updates about a particular listing to showing agents “R” who recently showed that listing, or provide feedback from a showing. The feedback may also include data generated by an electronic key box 50 that occurs as a function of the showings, such as number of showings, time spent at the subject property, return showings, etc. Listing agents “L” may also use the system 10 to receive automatic notification (e.g., email notices) when a showing occurs at their listings. The buyer “B” may also benefit as the system 10 provides a central repository for buyer information (e.g., details of each home the buyer has viewed).

The system 10 generally includes a subsystem 12 that may be controlled by a single owner. The subsystem 12 generally includes a listing recommendation server 14, a buyer server 16, a buyer database system 18, a log database system 20, and an electronic key server 22. A multiple of handheld devices 28, 30, 32, communicate with the subsystem 12. The first handheld device 28 is herein associated with the potential buyer “B,” the second handheld device 30 is associated with the showing agent “R” and the third handheld device 32 is associated with the listing agent “L.”

“Server” conveys its customary meaning and further includes a corporate datacenter that provides service and/or data connection, e.g., to the handheld device and/or an electronic locking device. “Handheld device” refers to a portable electronic device that is at least configured to send messages to, and/or receive messages from the listing recommendation server 14 over a long-range wireless communication network, such as a SMS, wireless, or cellular network. Examples of handheld devices include, but are not limited to: a cell phone; a personal digital assistant (“PDA”); a portable computer configured to store and playback digital pictures, songs, and/or videos; and the like. In addition, the handheld device is typically also configured for short-range wireless communications.

The listing recommendation server 14 communicates with the buyer database system 18, the log database system 20, and a data center 24. The buyer database system 18 includes a database 19 that stores rating and notes taken by the buyer “B,” and the log database system 20 includes a database 21 that collects activity data. The data center 24 may host one or more servers that may include, but not be limited to, a database for managing key holders 25A, a security database 25B that hosts security protocols, and a listing database 25C that stores extracted properties from external servers 26A, 26B, 26N.

The data center 24 communicates with the external data servers 26A-26N such as a Real Estate Transaction Standard (RETS) framework that stores MLS data. The MLS data includes information such as number of bedrooms, number of bathrooms, price of listing, etc. RETS is a framework that can be adopted by computer systems to receive data from the Multiple Listing Service (MLS) servers, as well as those of other real estate systems provided they also have software installed designed to communicate using the RETS framework. The National Association of Realtors refers to RETS as a “common language.” The data center 24 may also host real estate servers including a database for managing key box inventories, a security database that houses security protocols, a listing database of property listings, and/or other databases.

The listing recommendation server 14 hosts, for example, at least an analytics software application 32 that compiles and runs analytics against buyer ratings and MLS listing data from the data center 24. The buyer server 16 hosts a buyer application program interface (API) 34, and the electronic key server 22 hosts an electronic key API 36. An application program interface (API) is a set of routines, protocols, and tools for building software applications. An API specifies how software components should interact. APIs are used when programming graphical user interface (GUI) components. A server-side web API is a programmatic interface consisting of one or more publicly exposed endpoints to a defined request-response message system

The listing recommendation server 14 communicates with a real estate application 38 on the handheld device 28 through the buyer API 34 and buyer database system 18. An agent application 40 on the handheld device 30 communicates with the listing recommendation server 14 and the electronic key server 22. The buyer API 34 and the electronic key API 36 also communicate with the data center 24 through a firewall “F” or other security protocol.

The real estate application 38 may be a mobile application that may be used by the home buyer “B” to rate the properties they have seen via, for example, recordation of feedback and cataloging of the properties of interest. The real estate application 38 communicates with the buyer database system 18 through the buyer API 34 which then stores the ratings and notes taken by the home buyer in the buyer database system 18.

The agent application 40 may be a mobile application that may be used by the showing agent “R” to access the electronic key boxes 50. The electronic key API 36 communicates with the agent application 40 to sync activity from the electronic key boxes 50 to the electronic key API 36 (e.g., key boxes the key has opened), and showing notifications (e.g., messages about accessed key boxes and associated showing agent “R”).

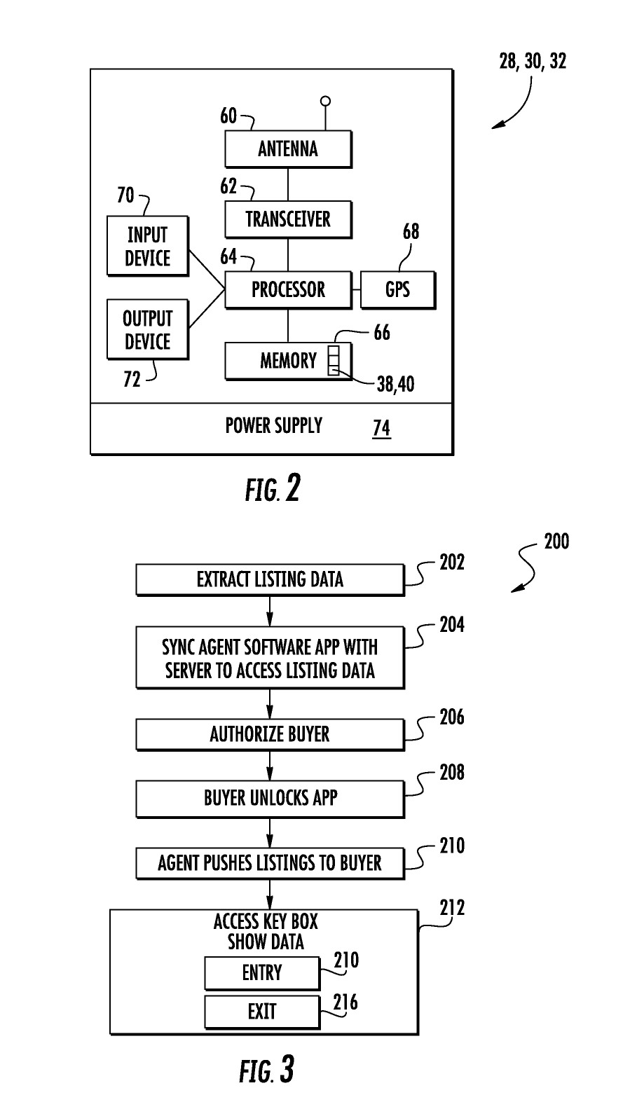

With reference to FIG. 2, each handheld device 28, 30, 32, generally includes a handheld device antenna 60, a handheld device transceiver 62, a handheld device processor 64, a handheld device memory 66, a GPS module 68, an input device 70, a display 72, and a handheld device power supply 74. The handheld device processor 64 may be any type of microprocessor having desired performance characteristics. The handheld device memory 66 may include any type of computer readable medium that stores the data and executable instructions described herein below. The executable instructions may be stored or organized in any manner and at any level of abstraction, such as in connection with one or more applications, processes, routines, procedures, methods, etc. The handheld device transceiver 62 is a transceiver of a type corresponding to the transceiver 62 and the handheld device antenna 60 is a corresponding antenna.

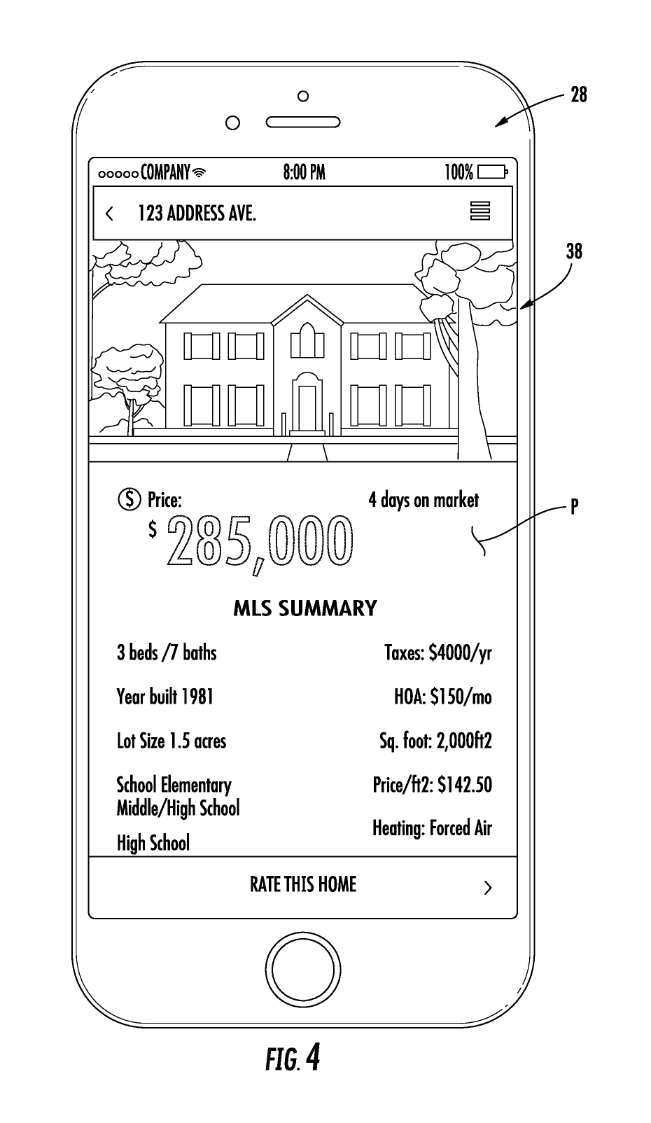

With reference to FIG. 3, a method 200 for operation of the system 10 is disclosed in terms of functional block diagrams. The functions are programmed software routines capable of execution in various microprocessor based electronics control embodiments and represented herein as block diagrams.

Initially, the owner of the subsystem 12 may have agreements with MLS to extract (202) MLS data from the external data servers 26A-26N into the listing recommendation server 14. Next, the agent application 40 syncs (204) with the listing recommendation server 14 and pulls MLS data for desired listings. This may be performed through an automated sync through the agent application 40. The showing agent “R” may also do a manual sync to obtain updated MLS data.

Through the agent application 40, the showing agent “R” can authorize (206) the home buyer “B” to access the desired listings of interest to the buyer “B”. Through the agent application 40, the showing agent “R” authorizes the buyer “B” through input of buyer identification information (e.g., name and email address.) The buyer identification information is then synced with the listing recommendation server 14. The listing recommendation server 14 then communicates with the buyer “B” (e.g., via email) that can include a link to an app store and a code to unlock (208) the real estate application 38. The buyer “B” is then authorized to download the real estate application 38 and desired listings, or to maintain the value of the showing agent “R” in the real estate transaction.

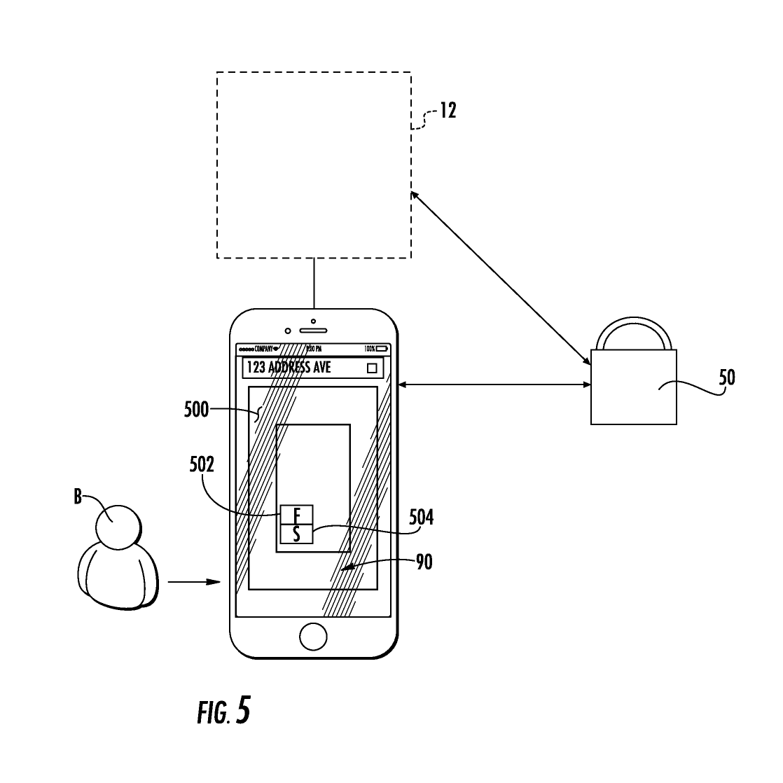

Through the agent application 40, the showing agent “R” can continue to push (210) listings to the real estate application 38. Access may be provided for one or more properties by a showing code, or other link to unlock one or more features in the real estate application 38. The showing agent “R” is able to selectively push properties (one example property illustrated by screenshot “P”; FIG. 4) to be viewable within the real estate application 38. The showing agent “R” also uses the agent application 40 to operate the electronic key box 50 to access (212) the property for showing to the buyer “B.” The electronic key box 50 may communicate with the subsystem 12 either directly such as via cellular communication or indirectly by short range communication through the agent application 40 (FIG. 5).

Access to the electronic key box 50 results in an entry timestamp recordation (214) being communicated by the electronic key box 50 to the electronic key server 22. The count of proprietary keys generated for the subject property is also updated and communicated to the subsystem 12.

When the showing is completed, the electronic key box 50 results in an exit time stamp recordation (216) being communicated by the electronic key box 50 to the electronic key server 22. Alternatively, the timestamp recordation (214, 216) may be based on a proximity to the electronic key box 50 determined by, for example, the GPS module 68 in the handheld device being proximate to the electronic key box 50. The difference between the timestamp (214, 216) is the length of the tour at the subject property.

With reference to FIG. 5, in addition to the features discussed above, the listing agent “L” can utilize a predictive sale date application 500 on their handheld device 32 to facilitate setting or adjusting a price for a subject property. The predictive sale date application 500 may be a separate application and/or a module of the real estate application 38, the agent application 40, or a separate Internet based interface.

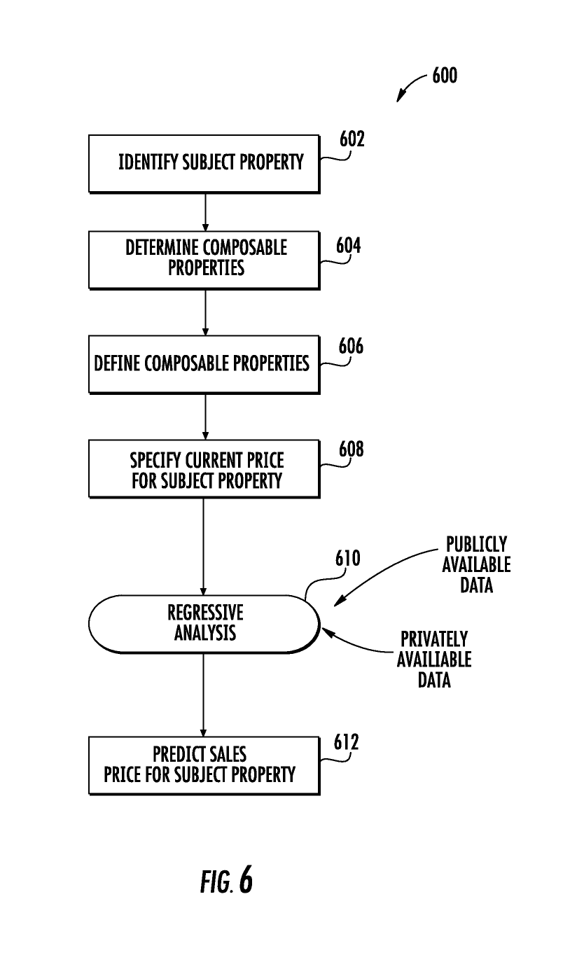

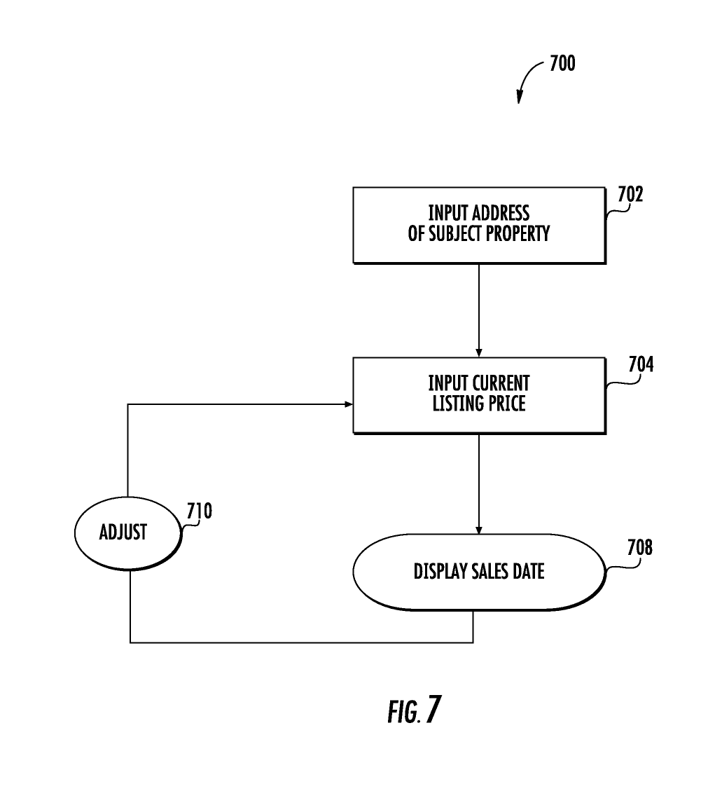

With reference to FIG. 6, a method 600 for predicting a sales date based upon showing data from comparable properties utilizing the predictive sale date application 500 is illustrated in terms of functional block diagrams. Initially, identification (e.g., by address) of a subject property is received (602) by the subsystem 12. The user, in one example, utilizes the predictive sale date application 500 to communicate the subject property address to the listing recommendation server 14 to obtain historical MLS data for the subject property. The subsystem 12 then obtains showing data from the electronic key box 50 of the subject property.

In response to the subject property, the predictive sale date application 500 determines (604) comparable properties from the listing recommendation server 14. The comparable properties may be adjusted by the user on the predictive sale date application 500 by, for example, selection or deselection of particular filters 502 (FIG. 5) (e.g., area, price, class, status, bedrooms, bathrooms, garage, fireplaces, basement, etc.) which refines (606) the comparable properties. The filters may be utilized to define the search of comparable properties.

Next, a current listing price for the subject property is received (608) though the predictive sale date application 500. The current listing price 504 (FIG. 5) for the subject property can be input either manually by the user into the predictive sale date application 500, or can be automatically retrieved by the predictive sale date application 500 from the MLS data.

Next, using regression analysis (610), a sales date for the subject property is predicted (612). The regression analysis may be a statistical process for estimating the relationships among variables and include various techniques for modeling and analyzing several variables, when the focus is on the relationship between a dependent variable and one or more independent variables. In this embodiment, the dependent variable may be the expected length of time on the market which depends on various independent variables such as variables that are publically available via MLS data (e.g., historical sale data such as number of days on the market before sale, property type, year built, lot size, number of bedrooms, number of bathrooms, basement, garage, square feet, location, schools, price, taxes, price history, tax history, cooling type, heating type, appliances included, attic, number of rooms, fireplace, exterior material, driveway type, porch, sewer/water, etc.).

Other independent variables may be only privately available through the subsystem 12 due to the use of the electronic key box 50 and the data acquired thereby (e.g., a number of showings/time period, an average time at each showing, a maximum time at showing, an average showing time/square feet, an average showing time/(square feet plus lot size, etc.). that is, use of the electronic key box 50 essentially corresponds to when home showings have occurred. This privately available data may be obtained by the predictive sale date application 500 which pulls from the listing recommendation server 14 which is in communication with the data center 24 and the database for managing key holders 25A (FIG. 1). Over time, as prospective buyers view the subject property the sales date forecast may be updated based on the current traffic (e.g., showing data) from the subject property. The update may be based on the length of the tour and number of viewings over a predefined time range.

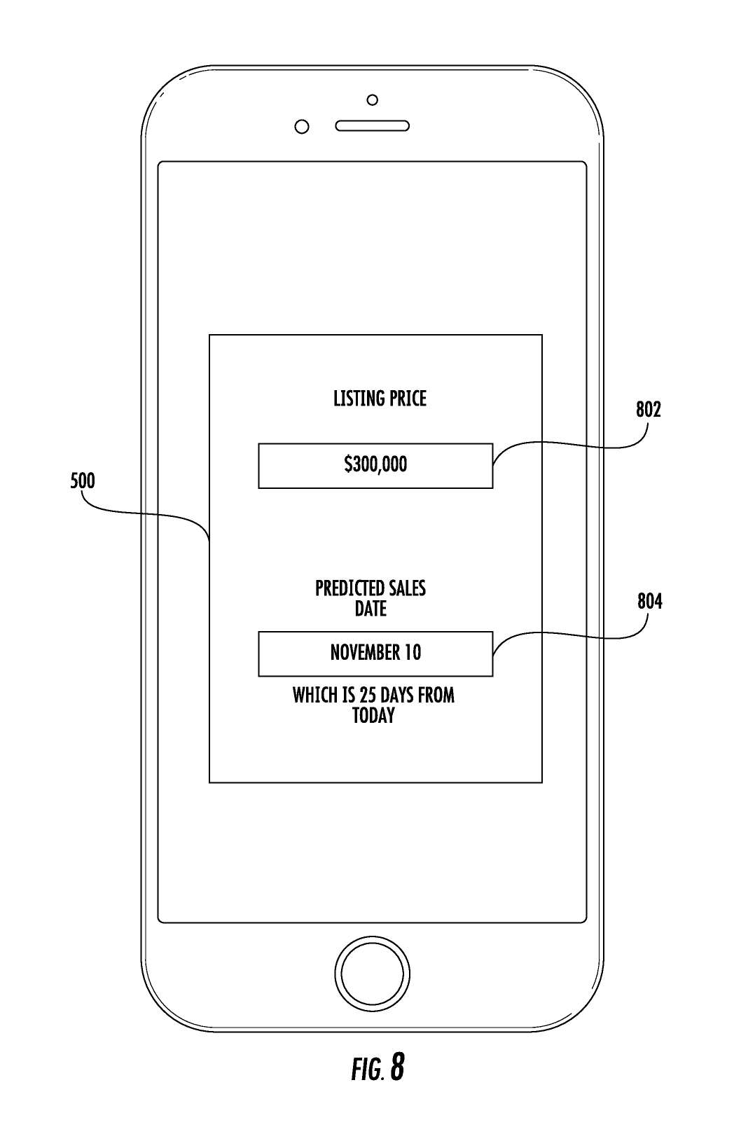

With reference to FIG. 7, a method 700 of operation of the predictive sale date application 500 is disclosed in terms of functional block diagrams. The functions are programmed software routines and executable instructions capable of execution in various microprocessor based electronic control embodiments and represented herein as block diagrams.

Initially, a user inputs (702) the address of the subject property into the predictive sale date application 500 (802; FIG. 8). The user may then input (704) the current listing price into the predictive sale date application 500. Optionally, the current listing price is retrieved by the subsystem 12 from MLS data. Then, from the historical data such as the public and private data identified above, regression analysis is utilized to predict (706) an anticipated sales date based on current showing data of the subject property and comparable properties. The forecasted anticipated sales date is then displayed (708) on the predictive sale date application 500 (804; FIG. 8). The user may adjust (710) the listing price to receive an updated predicted sales date.

In one or more embodiments, the predicted sales date may be displayed (708) as a qualitative measure relative to the demand of the property. For example, a predicted sales date less than a week may be “Hot”, 1-3 weeks may be “Active,” 4+ weeks may be “Cold.” Such qualitative measure may be further displayed in conjunction with colors or other indicators to facilitate comparison.

By using historical data as a forecasting tool, the predictive sale date application 500 permits real estate agents to be able to give the seller some indication of “feedback” even when not directly received from the buyer's agents as to the potential sales date of their property.

The elements described and depicted herein, including in flow charts and block diagrams throughout the figures imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed:

1. A method for predicting an anticipated sales date for a subject property, comprising:
determining a set of comparable properties based on a subject property;
determining showing data for the subject property;
determining showing data for at least one of the set of comparable properties;
determining historical sale data for at least one of the set of comparable properties; and
predicting an anticipated sales date for the subject property based at least in part on the showing data of the subject property, the showing data for the at least one of the set of comparable properties and the historical sale data for the at least one of the set of comparable properties.

2. The method as recited in claim 1, wherein predicting the anticipated sales date is performed using regression analysis based on the historical data.

3. The method as recited in claim 2, wherein a dependent variable of the regression analysis is the anticipated sales date.

4. The method as recited in claim 3, wherein an independent variable of the regression analysis includes publically available data.

5. The method as recited in claim 4, wherein the publically available data includes at least one of number of days on the market before sale, property type, year built, lot size, number of bedrooms, number of bathrooms, basement, garage, square feet, location, schools, price, taxes, price history, tax history, cooling type, heating type, appliances included, attic, number of rooms, fireplace, exterior material, driveway type, porch, sewer/water.

6. The method as recited in claim 3, wherein an independent variable of the regression analysis includes privately available data.

7. The method as recited in claim 6, wherein the privately available data includes a number of showings/time period.

8. The method as recited in claim 6, wherein the privately available data includes at least one of an average time at each showing, a maximum time at a showing, an average showing time/square feet, an average showing time/(square feet plus lot size).

9. The method as recited in claim 1, further comprising communicating the anticipated sales date for the subject property to a handheld device operating a predictive sale date application.

10. The method as recited in claim 9, further comprising displaying the anticipated sales date for the subject property on the predictive sale date application as a qualitative measure relative to the demand of the subject property.

11. The method as recited in claim 10, wherein the qualitative measure is based on a time associated with the anticipated sales date for the subject property.

12. The method as recited in claim 1, wherein the predicting is performed by a showing application on a handheld device.

13. The method as recited in claim 1, wherein the predicting is performed by a subsystem.

14. The method as recited in claim 1, wherein the set of comparable properties based on the subject property is related to at least one of a comparable geographical area, a comparable price, a comparable number of bedrooms, and a comparable number of bathrooms.

15. A system for predicting a sales date for a subject property, comprising:
an electronic key box;
an electronic key server in communication with the electronic key box, the electronic key server including a database that stores showing data associated with the electronic key box;
a buyer server in communication with the electronic key server;
a buyer storage system in communication with the buyer server and the electronic key server, the buyer storage system including a database that stores historical sale data; and
a software application configured to determine a set of comparable properties from the property data stored in the buyer storage system based on a subject property stored in the buyer storage system, the software application configured to predict an anticipated sales date for the subject property based at least in part on the showing data of the subject property, the showing data for the at least one of the set of comparable properties and the historical sale data for the at least one of the set of comparable properties.

16. The system as recited in claim 15, further comprising a handheld device running a predictive sale date application, the handheld device in electronic communication with the electronic key server and the electronic key box.

17. The system as recited in claim 16, wherein the analytics software application configured to receive privately available data.

18. The system as recited in claim 17, wherein the privately available data is received from the electronic key server in communication with at least one electronic key box.

19. The system as recited in claim 16, wherein the analytics software application configured to receive publicly available data.

20. The system as recited in claim 19, wherein the publicly available data is received from a data center that communicates with a Real Estate Transaction Standard (RETS) framework that stores MLS data.

21. The system as recited in claim 16, wherein the software application is hosted on a handheld device, the handheld device in communication with the buyer server.

22. The system as recited in claim 16, wherein the software application is hosted on a listing recommendation server, the listing recommendation server in communication with the buyer server and the electronic key server.
